(19) United States
(12) Patent Application Publication
(10) Pub. No.: US 2006/0047576 A1
(43) Pub. Date: Mar. 2, 2006

(54) Automated memory and accessory purchasing agent for use in a mobile terminal

(75) Inventors: Janne Aaltonen, Turku (FI); Juha Salo, Littoinen (FI)

Correspondence Address: ALSTON & BIRD LLP;BANK OF AMERICA PLAZA, 101 SOUTH TRYON STREET, SUITE 4000, CHARLOTTE, NC, 28280-4000, US

(73) Assignee: Nokia Corporation, Espoo (FI)

(21) Appl. No.: 10/929,865

(22) Filed: Aug. 30, 2004

(51) Int. Cl. G06Q 30/00

(52) U.S. Cl. 705/26

(57) ABSTRACT

The invention includes computer program products, devices and systems that monitor replaceable memory availability on a mobile terminal device or accessory availability for a mobile terminal device and, based on predetermined thresholds, generate purchasing options for the replaceable memory or accessory. In this regard, the invention is able to provide a mobile terminal user options to purchase additional replaceable memory or accessories when the memory is close to capacity or when the accessory is either exhausted or has become commercially available. The purchasing options that are presented to the user will typically take into account best prices for the memory, both at retail locations and online locations, as well as, user specific purchasing criteria, such as acceptable price range, loyalty program membership, preferred vendors and location of the user and/or the mobile terminal. In addition, the purchasing options that are provided to the user may be such that they are preconfigured by the user to automatically purchase additional memory or an accessory if a certain threshold of memory or accessory capacity is exceeded.

### FIELD OF THE INVENTION

The present invention relates to providing purchasing information to a mobile terminal user and, more specifically, to methods, systems, devices and computer program applications for providing a mobile terminal user purchasing options when a terminal resource is depleted or new terminal accessories become available.

### BACKGROUND OF THE INVENTION

In today's mobile device environment, many mobile devices, otherwise referred to herein as mobile terminals, are equipped with the means to communicate and receive data from various communication mediums. For example, the mobile telephone is no longer limited to cellular voice communication and may additionally include means for Internet communication, electronic mail (email) communication, Short Message Service (SMS) communication, Multimedia Message Service (MMS) communication and the like. In addition these devices are equipped with the means to execute many software applications, such as utility applications, gaming applications and the like. With this increase in communication and application functionality, comes a desire to have the mobile terminal store an increased amount of content. For example, email, SMS, and MMS communications may require storage, as well as the data attached to these communications, such as image data or video data. Additionally, information in the form of image, video and audio files downloaded from the Internet or acquired by other means may require storage on the mobile terminal.

To address the need for an increase in storage capacity without negatively impacting the overall cost of the mobile terminal, an increasing number of such devices are being marketed with expandable memory, in the form of removable solid state memory. Such memory may take the form, of a Multi Media Card (MMC), flash drive, memory stick or the like. (For the sake of brevity and clarity, the term MMC is used herein as a generic term that applies to all forms of expandable and replaceable memory). This type of memory allows the user of the mobile terminal to expand the storage capacity on an as needed basis. However, this MMC memory is typically either limited in storage capacity or, in larger storage capacity units, may be cost prohibitive. As such, as the terminal acquires more storable content, the user must delete some of the content already stored, employ compression methods or purchase additional MMC memory. Deleting stored content and employing compression methods are generally viewed as a temporary remedy. Ultimately, a user will be faced with the decision to either purchase additional memory or forego storing any additional content. Typically, the later option is not viable.

Purchasing additional MMC memory for a mobile terminal is often problematic. Typically, a user will wait until their MMC memory is full before they purchase additional memory. Purchasing additional memory requires the user to either frequent a retail site or make an online purchase and wait for delivery. As such, the mobile terminal is unable to store any content until the user physically acquires the additional memory.

Currently, mobile terminals are configured to only be reactive in terms of informing the user of memory availability. For example, in the instance in which a user desires to access a network service and acquire storable content, e.g. an audio file or video file, the terminal may, if available memory is limited, inform the user that insufficient memory exists to perform the requisite storage function. Typically, such information is communicated via a user-interface, such as a display reading. In most instances, this is the first indication provided to the user that the MMC memory is either nearing full capacity or at full capacity. It is this reactive type of information that triggers the user of the mobile terminal to purchase additional memory.

In the same regard, other mobile terminal exhaustive resources, such as batteries and the like will reach the end of their useful life with no indication being provided to the terminal user. In such case, the user may be left with an inoperable mobile terminal until the battery can be replaced. In addition, in the case of a rechargeable battery, the user will often mistake the failure of a battery as a failure of the overall mobile terminal device. Thus, causing the user to erroneously replace the terminal instead of a more cost prudent replacement of the battery.

Thus, a need exists to provide mobile terminal users a real-time solution to overcoming problems related to insufficient availability of memory and other terminal exhaustive resources. Such a method and applications should provide the user with immediate purchasing options, and in some instances automatic purchasing, of memory or other terminal resources when the memory or resource meets a minimum threshold. Additionally, the mobile terminal user would greatly benefit from a method and application that predicts the time at which the terminal will reach a “memory full” state or otherwise become exhaustive in terms of a terminal resource and take necessary action to inform the user of immediate purchasing options.

Also, the mobile terminal user would benefit from methods and applications that provide the user with real-time purchasing options of accessories and/or services associated with the mobile terminal. Typically, a device manufacturer will be limited to advertising to inform a user of accessories and/or services that may be of interest to a user. Such advertising has a limited audience that may not reach all of the users of the terminals. Thus, a user of the terminal would benefit from real-time notice of such accessories and services and the ability to purchase these accessories and services in an efficient manner.

### BRIEF SUMMARY OF THE INVENTION

The present invention provides for computer program products, devices and systems that monitor replaceable memory availability on a mobile terminal device or accessory availability for a mobile terminal device and, based on predetermined thresholds, generate purchasing options for the replaceable memory or accessory. The mobile terminal device may include, but is not limited to, devices that include a memory expansion module, such as a mobile telephone, a personal digital assistant (PDA), a digital imaging device or the like. In this regard, the present invention is able to provide a mobile terminal user options to purchase additional replaceable memory or accessories when the memory is close to capacity or when the accessory is either exhausted or has become commercially available. The purchasing options that are presented to the user will typically take into account best prices for the memory, both at retail locations and online locations, as well as, user specific purchasing criteria, such as acceptable price range, loyalty program membership, preferred vendors and location of the user and/or the mobile terminal. In addition, the purchasing options that are provided to the user may be such that they are preconfigured by the user to automatically purchase additional memory or an accessory if a certain threshold of memory or accessory capacity is exceeded. As such, the present invention limits the likelihood of the mobile terminal reaching full memory or accessory capacity without the user having purchased additional memory or accessories. In terms of accessories, the invention insures that accessory suppliers have the ability to provide accessory information to users when new accessories are introduced into the market place or when the user has shown a need to acquire such accessories.

In one embodiment of the invention, a computer program or a computer program product is defined for providing replaceable memory purchasing options to a mobile terminal user. The computer program product includes a computer readable storage medium having computer-readable program instructions embodied in the medium. The computer-readable program instructions include first instructions for monitoring availability of replaceable memory associated with the mobile terminal and second instructions for generating one or more memory purchase options, if the first instructions determine that the availability of memory is such that additional memory is recommendable. Typically, once the second instructions have generated the one or more memory purchase options the options will be displayed on a display associated with the mobile terminal device. The application of the present invention may be executed at the mobile terminal or it may be executed at a remote network device that is in network communication with the mobile terminal.

Typically, the first instructions will determine if the available replaceable memory, such as a multimedia memory card or the like, has reached a predetermined threshold level of capacity. If the predetermined threshold level has been met or exceeded, the second instructions will generate one or more memory purchase options. Alternatively, the first instructions will predict the time at which the replaceable memory will likely reach full capacity. If the predicted time is less than a predetermined threshold, the second instructions will generate one or more memory purchase options.

The memory purchase options that are generated by the second instructions are typically generated by the application accessing a vendor database that includes a listing of current vendors, typically both retail locations and online locations, that offer replaceable memory devices, such as Multi Media Cards (MMC), memory sticks, flash drives, or the like. In addition to a listing of the vendors the vendor database will typically include a price listing corresponding to the products available from a given vendor. Additionally, the memory purchase options that are generated by the second instructions are typically generated by the application accessing a user profile database. The user profile database will include one or more mobile terminal user profiles that include information relevant to the purchase of additional memory. For example, a user profile may include user preferred vendors, user preferred memory prices, user loyalty program membership, credit card information and user home or shipping address. Also, the memory purchase options that are generated by the second instructions may provide for the application to access a mobile terminal location-tracking device, such as a Global Positioning System (GPS) device, to determine the location of the mobile terminal as a determining factor in generating the memory purchase options, i.e., determining the closest vendor in proximity to the mobile terminal.

In one embodiment of the invention the second instructions may be configured by the user to automatically purchase additional memory based on predefined criteria defined by the terminal user. For example, the user may configure the application to automatically purchase memory if the replaceable memory capacity exceeds a predefined limit or if available memory price reaches a predefined price. In this instance the memory purchase option that is generated and provided to the user is an option to automatically purchase memory based on the user defined automatic purchase criteria.

The computer program and product for providing replaceable memory purchase options may also include third instructions for cleansing the data stored in the replaceable memory. Cleansing the data will typically provide for deleting data stored in the replaceable memory that is determined to be unused for a predetermined period of time. The cleansing of data may occur on a predefined periodic schedule, at the bequest of the user or when the memory capacity reaches a predefined limit.

The computer program and product for providing replaceable memory purchase options may also include third instructions for compressing the data stored in the memory. Compression of data may occur on certain pre-specified data types, such as video data or compression may occur on data stored in the replaceable memory that is determined to be unused for a predetermined period of time. The compression of data may occur on a predefined periodic table, at the bequest of the use or when the memory capacity reaches a predefined limit.

In an alternate embodiment of the invention, a computer program or computer program product for providing accessory purchasing options to a mobile terminal user is defined. The computer program product includes a computer readable storage medium having computer-readable program instructions embodied in the medium. The computer-readable program instructions include first instructions for monitoring availability of one or more accessories associated with the mobile terminal and second instructions for generating accessory purchase options, if the first instructions determine the availability of accessories associated with the mobile terminal. Once the application has generated the accessory purchase options, the options will typically be displayed on a display associated with the mobile terminal. Accessories are defined as any peripheral device that may benefit the mobile terminal user. For example, accessories may include audio listening devices, protective cases, batteries, battery chargers, auxiliary power adapters and the like. The application may be executed at the mobile terminal or the application may be executed at a remote network device that is in network communication with the mobile terminal.

Typically, the first instructions for monitoring the availability of accessories associated with the mobile terminal will be communication with accessory suppliers or manufacturers to determine the availability of accessories. The first instructions may periodically communicate with the accessory suppliers to determine availability or the suppliers and manufacturers may periodically send communications to the application concerning accessory availability. In addition, the first instructions may provide for determining if the mobile terminal has a need to acquire accessories. For example, the first instructions may monitor accessories, such as rechargeable batteries or the like, that have a finite life and determine that a new battery is either needed or will be needed in the near future. Additionally, the first instructions may determine that the device has implemented a new application or service that warrants information concerning accessories related to the service. For example, if the mobile terminal implements an audio player application, the terminal and user may benefit from purchase information related to headphones, ear buds or the like.

The accessory purchase options that are generated by the second instructions are typically generated by the application accessing a vendor database that includes a listing of current vendors, typically both retail locations and online locations, that offer such accessories. In addition to a listing of the vendors, the vendor database will typically include a price listing corresponding to the products available from a given vendor. Additionally, the accessory purchase options that are generated by the second instructions are typically generated by the application accessing a user profile database. The user profile database will include one or more mobile terminal user profiles that include information relevant to the purchase of accessories. For example, a user profile may include user preferred vendors, user preferred accessory prices, user loyalty program membership, credit card information and user home or shipping address.

Also, the accessory purchase options that are generated by the second instructions may provide for the application to access a mobile terminal location-tracking device, such as a Global Positioning System (GPS) device, to determine the location of the mobile terminal as a determining factor in generating the accessory purchase options, i.e., determining the closest vendor in proximity to the mobile terminal.

The second instructions may be configured by the user to automatically purchase accessories based on predefined criteria defined by the terminal user. For example, the user may configure the application to automatically purchase accessories if the accessory price reaches a predefined price. In this instance the accessory purchase option that is generated and provided to the user is an option to automatically purchase the accessory based on the user defined automatic purchase criteria.

The invention is also defined by a mobile terminal device that includes a memory expansion module that receives removable memory devices, a processing unit in communication with the memory expansion module that executes an application that monitors the availability of memory associated with the removable memory devices and generates one or more memory purchase options if the monitoring determines that the availability of memory is such that additional memory is recommendable. The terminal device also includes a display in communication with the processing unit that provides a user with a visual display of the one or more memory purchase options.

Typically, the mobile terminal will include an internal memory unit, in communication with the processing unit, that stores a database of one or more memory vendors and the prices for memory corresponding to the vendors. The application will access the database of memory vendors to generate the memory purchase options. Additionally, the mobile terminal will typically include a user profile database, either stored in the same internal memory unit as the memory vendor database or stored in a separate internal memory device. The application will access the user profile database to generate the memory purchase options. Information stored in the user profile that relates to memory purchasing may include, but is not limited, preferred vendors, preferred purchase price, vendor loyalty programs, credit card information, user home and/or shipping address and the like.

Additionally, the mobile terminal may include a location tracking device, such as a Global Positioning System (GPS) device, that is in communication with the processing unit. The application accesses the location tracking device to determine the location of the mobile terminal when generating the memory purchase options.

The invention is also embodied in a mobile terminal device that provides accessory purchase options. The device includes a processing unit that executes an application that monitors the availability of accessories associated with the mobile terminal device devices and generates accessory purchasing options if the monitoring determines the availability of accessories associated with the mobile terminal device. The device also includes a display in communication with the processing unit that provides a user with a visual display of the accessory purchase options.

Typically, the mobile terminal will include an internal memory unit, in communication with the processing unit, that stores a database of one or more accessory vendors and the prices for accessories corresponding to the vendors. The application will access the database of accessory vendors to generate the accessory purchase options. Additionally, the mobile terminal will typically include a user profile database, either stored in the same internal memory unit as the memory vendor database or stored in a separate internal memory device. The application will access the user profile database to generate the accessory purchase options. Information stored in the user profile that relates to accessory purchasing may include, but is not limited, preferred vendors, preferred purchase price, vendor loyalty programs, credit card information, user home and/or shipping address and the like.

Additionally, the mobile terminal may include a location tracking device, such as a Global Positioning System (GPS) device, that is in communication with the processing unit. The application accesses the location tracking device to determine the location of the mobile terminal when generating the accessory purchase options.

The invention is also defined by a system for providing memory purchase options to a mobile terminal. The system includes a mobile terminal device that includes a memory expansion module that receives removable memory devices, a processing unit in communication with the memory expansion module and a display in communication with the processing unit. Additionally, the system includes a memory purchase agent application that is in communication with the mobile terminal device that monitors the availability of memory associated with the removable memory devices and generates one or more memory purchase options if the monitoring determines that the availability of memory is such that additional memory is recommendable The display of the mobile terminal device provides for a visual display of the one or more memory purchase options generated by the memory purchase agent application. The system embodiment of the present invention highlights that the memory purchase agent application may be executed at a remote network device that is in network communication with the mobile terminal device or it may be executed on the mobile terminal device.

The system embodiment may further include vendor databases and/or user profile databases, similar in make-up and function to the vendor databases and user profiles discussed above. However, in the system embodiment the vendor database and the user profile database may reside at separate network storage device, at the same network storage device, at the same network device that executes the memory purchase agent application or at the mobile terminal device.

The invention is also embodied in a user interface application that includes first instructions for displaying to a mobile terminal user one or more memory or mobile terminal accessory purchase options and second instructions for effecting the purchase of memory or a mobile terminal accessory based on user inputs to the displayed memory purchase options. In the case of memory, the first instructions will typically be triggered by monitoring available memory in the mobile terminal. Thus, if the available memory falls below a predefined limit the user-interface application will display the memory purchase options. In the case of mobile terminal accessories, the first instructions will typically be triggered by either monitoring the availability of newly available mobile terminal accessories or monitoring the needs of the mobile terminal. Typically, the displayed purchase options will be options to purchase the memory or accessory from a networked merchant; i.e. online merchant and effecting the purchase of memory based on user inputs to the displayed memory purchase options will then involve communicating a memory or accessory purchase order to a networked merchant.

As such the present invention mitigates problems related to mobile terminals depleting available replaceable memory and subsequently purchasing additional memory. The present invention also addresses the need to provide mobile terminal users with accessory purchase options when needs dictate such. In this regard, the present invention provides computer program products, devices and systems that monitor replaceable memory availability on a mobile terminal device or accessory availability for a mobile terminal device and, based on predetermined thresholds, generate purchasing options for the replaceable memory or accessory. The application thus is able to provide a mobile terminal user options to purchase additional replaceable memory or accessories when the memory is close to capacity or when the accessory is either exhausted or has become commercially available. The purchasing options that are presented to the user will typically take into account best prices for the memory, both at retail locations and online locations, as well as, user specific purchasing criteria, such as acceptable price range, loyalty program membership, preferred vendors and location of the user and/or the mobile terminal. In addition, the purchasing options that are provided to the user may be such that they are preconfigured by the user to automatically purchase additional memory or an accessory if a certain threshold of memory or accessory capacity is exceeded. As such, the present invention limits the likelihood of the mobile terminal reaching full memory or accessory capacity without the user having purchased additional memory or accessories. In terms of accessories, the invention insures that accessory suppliers have the ability to provide accessory information to users when new accessories are introduced into the market place or when the user has shown a need to acquire such accessories.

### BRIEF DESCRIPTION OF THE DRAWINGS

Having thus described the invention in general terms, reference will now be made to the accompanying drawings, which are not necessarily drawn to scale, and wherein:

FIG. 1 is a block diagram of a mobile device that executes a memory monitor and memory purchase option application, in accordance with an embodiment of the present invention.

FIG. 2 is a block diagram of a system for monitoring memory of a mobile terminal and providing memory purchase options to the mobile terminal, in accordance with an embodiment of the present invention.

FIG. 3 is a flow diagram of a method for monitoring memory in a mobile terminal, in accordance with an embodiment of the present invention.

FIG. 4 is a flow diagram of a method for monitoring memory in a mobile device, providing memory purchase options and placing a memory order, in accordance with an embodiment of the present invention.

### DETAILED DESCRIPTION OF THE INVENTION

The present inventions now will be described more fully hereinafter with reference to the accompanying drawings, in which some, but not all embodiments of the invention are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

The present invention provides for computer program products, devices and systems that monitor replaceable memory availability on a mobile terminal device or accessory availability for a mobile terminal device and, based on predetermined thresholds, generate purchasing options for the replaceable memory or accessory. The mobile terminal device may include, but is not limited to, devices that include a memory expansion module, such as a mobile telephone, a personal digital assistant (PDA), a digital imaging device or the like. In this regard, the present invention is able to provide a mobile terminal user options to purchase additional replaceable memory or accessories when the memory is close to capacity or when the accessory is either exhausted or has become commercially available. The purchasing options that are presented to the user will typically take into account best prices for the memory, both at retail locations and online locations, as well as, user specific purchasing criteria, such as acceptable price range, loyalty program membership, preferred vendors and location of the user and/or the mobile terminal. In addition, the purchasing options that are provided to the user may be such that they are preconfigured by the user to automatically purchase additional memory or an accessory if a certain threshold of memory or accessory capacity is exceeded. As such, the present invention limits the likelihood of the mobile terminal reaching full memory or accessory capacity without the user having purchased additional memory or accessories. In terms of accessories, the invention insures that accessory suppliers have the ability to provide accessory information to users when new accessories are introduced into the market place or when the user has shown a need to acquire such accessories.

In addition, the present invention provides for computer program products, devices and systems for monitoring other mobile terminal related accessories and providing purchasing options for these accessories. The other accessories may be consumables, similar to replaceable memory, such as mobile terminal batteries or the like. Alternatively, the other accessories may be any other peripheral that the mobile device would benefit from. For example, cases, protective covers, audio listening devices, battery charging, power adapters and the like. In terms of accessories, the monitoring that the application performs may be monitoring of the useful life (if the accessory is a consumable), monitoring of new availability of an accessory offered by an accessory vendor or monitoring of mobile terminals need to acquire accessories (e.g. mobile terminal subscribes to audio download service and the need to acquire related peripherals and accessories is apparent). For the sake of brevity the detailed description is limited to discussion related to monitoring memory and providing memory purchase options. However, as noted the invention applies equally to monitoring other mobile terminal related accessories and providing purchasing option for theses accessories.

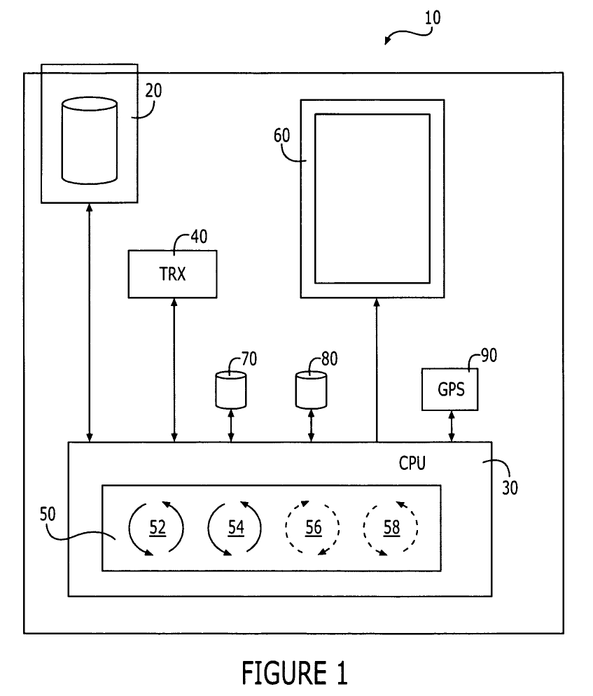

FIG. 1 is a block diagram of a mobile terminal, in accordance with an embodiment of the present invention. The mobile terminal 10 may be a cellular telephone, a personal digital assistant (PDA), a digital camera or any other mobile terminal equipped with a memory expansion module 20. The mobile terminal will include a processing unit, such as central processing unit 30 that is in communication with the memory expansion module and a transceiver, such as cellular transceiver 40 that receives and transmits network communications. The central processing unit will execute a memory monitor and purchase agent application 50 that monitors the usage of the memory associated with the expansion module and generates memory purchase options in response to the monitoring of memory usage. The memory purchase options are then provided to the user of the mobile terminal through a user interface, such as display 60, which is in communication with the processing unit.

The memory monitor and purchase agent application may take the tangible form of a computer program product. The computer program product will include a computer readable storage medium having computer-readable program instructions embodied in the medium. The computer program product may be a storage disc, tape, memory unit or other storage device or the product may take the form of code programmed into a processing unit.

It is noted that while this embodiment of the invention executes the memory purchase agent module at the mobile terminal device, in alternate embodiment the application is executed at remote network devices. In such embodiment, memory monitoring data is transmitting via the cellular transceiver or other transceiver to the network device and the application generates memory purchasing options which are then communicated, via the cellular network or some other wired or wireless network, to the mobile terminal where they are subsequently displayed on the mobile terminal display.

The memory monitor and purchase agent application will include first instructions 52 that monitor the availability of replaceable memory and second instructions 54 that generate memory purchase options if the first instructions determine that the availability of memory is such that additional memory is recommendable. The first instruction may monitor memory by determining if the available memory is no more than a predetermined minimum threshold. If the available memory falls below the threshold the second instructions will generate memory purchase options. Alternatively, the first instructions may monitor memory by predicting the time at which the memory will reach full capacity based on the current rate of memory consumption. If the predicted time falls below a minimum threshold the second instructions will generate memory purchase options. Additionally, the second instructions may be configured such that the memory purchase option is an automatic purchase of memory based upon criteria specified by a terminal user.

The memory purchase agent application may also include additional optional instructions such as third instructions 56 for cleansing the replaceable memory. Cleansing the memory typically entails deleting files or data from the memory that have been inactive for a specified period of time. The cleansing instructions may be executed on a predetermined periodic schedule, at the bequest of the terminal user or after a determination is made that the replaceable memory capacity is at a predetermined threshold. The memory purchase agent application may also include additional optional fourth instructions 58 for compressing the replaceable memory data. Compressing the memory typically entails compressing the data in files that have been inactive for a specified period of time. The cleansing instructions may be executed on a predetermined periodic schedule, at the bequest of the terminal user or after a determination is made that the replaceable memory capacity is at a predetermined threshold.

The mobile terminal may additionally include one or more memory devices such as first memory device 70 that stores a vendor database and second memory device 80 that stores terminal user profiles. In alternate embodiments the databases may be stored within one memory device. Also, the memory devices may reside on a remote network device that are in network communication with the mobile terminal. The databases are used by the second instructions of the memory purchase agent application to generate memory purchase options. The vendor database will typically include a listing of memory vendors, both online and retail, the types and brands of memory offered by each vendor and the corresponding price for memory established by each vendor. The user profile data may include memory purchase relevant data, such as preferred vendors, acceptable prices or price ranges, loyalty program memberships, credit card information, user home and/or shipping address and the like. These databases are accessed by the application to provide the user with up-to-date, user-specific and best-price options for purchasing memory.

The mobile terminal may additionally include a location tracking device 90, such as a Global Positioning System (GPS) device or the like. Additionally the mobile terminal may use location determination systems of the cellular network (external to the terminal), Wireless Local Area Network (WLAN), Bluetooth hot spot or RFID as location determining devices. The location tracking device is in communication with the processing unit, such that, the application will access the location tracking device to determine the location of the terminal. The application can then tailor purchasing options based upon the location of the terminal. For example, the application can provide the user with a purchase option related to the closest in proximity retail vendor. This would satisfy the need of the mobile terminal user that has a desire for immediate use of additional memory.

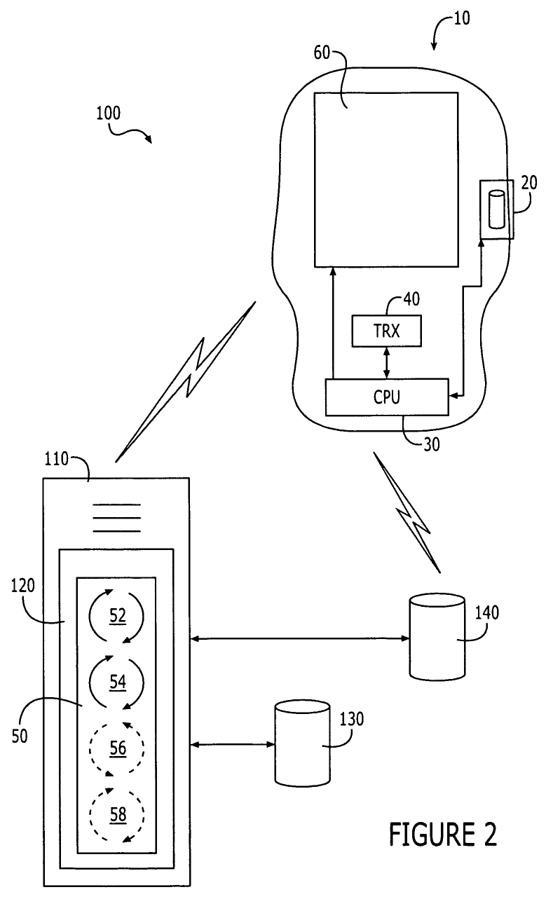

FIG. 2 is block diagram of a system for monitoring replaceable memory in a mobile terminal and providing purchase options, in accordance with an embodiment of the present invention. The system embodiment differs from the mobile terminal embodiment in that the application may be executed external to the mobile terminal and the various databases accessed by the application may be external to the mobile terminal. The system 100 includes a mobile terminal 10, in accordance with an embodiment of the present invention. The mobile terminal 10 may be a cellular telephone, a personal digital assistant (PDA), a digital camera or any other mobile terminal equipped with a memory expansion module 20. The mobile terminal will include a processing unit, such as central processing unit 30 that is in communication with the memory expansion module and a transceiver, such as cellular transceiver 40 that receives and transmits network communications.

The system will typically include a remote network device 110, such as a server, that is in network communication with the mobile terminal. The communication link between the remote network device and the mobile terminal may be cellular communication or any other known wired or wireless communication medium. The remote network device will include a processing unit 120 that executes the memory monitor and purchase agent application 50 of the present invention. The application will monitor the usage of the memory associated with the expansion module and generate memory purchase options in response to the monitoring of memory usage. Memory monitoring data is transmitted from the mobile terminal, via the network communication link, such as the cellular network, to the remote network device and the application determines if memory purchase options should be generated based on memory consumption. The memory purchase options are then communicated to the mobile terminal and provided to the user of the terminal through a user interface, such as display 60, which is in communication with the processing unit of the mobile terminal.

The memory monitor and purchase agent application will include first instructions 52 that monitor the availability of replaceable memory and second instructions 54 that generate memory purchase options if the first instructions determine that the availability of memory is such that additional memory is recommendable. The first instruction may monitor memory by determining if the available memory is no more than a predetermined minimum threshold. If the available memory falls below the threshold the second instructions will generate memory purchase options. Alternatively, the first instructions may monitor memory by predicting the time at which the memory will reach full capacity based on the current rate of memory consumption. If the predicted time falls below a minimum threshold the second instructions will generate memory purchase options. Additionally, the second instructions may be configured such that the memory purchase option is an automatic purchase of memory based upon criteria specified by a terminal user.

The memory purchase agent application may also include additional optional instructions such as third instructions 56 for cleansing the replaceable memory. Cleansing the memory typically entails deleting files or data from the memory that have been inactive for a specified period of time. The cleansing instructions may be executed on a predetermined periodic schedule, at the bequest of the terminal user or after a determination is made that the replaceable memory capacity is at a predetermined threshold. The memory purchase agent application may also include additional optional fourth instructions 58 for compressing the replaceable memory data. Compressing the memory typically entails compressing the data in files that have been inactive for a specified period of time. The cleansing instructions may be executed on a predetermined periodic schedule, at the bequest of the terminal user or after a determination is made that the replaceable memory capacity is at a predetermined threshold.

The system may additionally include one or more network storage devices such as first storage device 130 that stores a vendor database and second storage device 140 that stores terminal user profiles. In alternate embodiments the databases may be stored within one network storage device or either or both databases may be stored on the same network device that executes the application or stored within the mobile terminal. The databases are accessed by the second instructions of the memory purchase agent application to generate memory purchase options. The vendor database will typically include a listing of memory vendors, both online and retail, the types and brands of memory offered by each vendor and the corresponding price for memory established by each vendor. The user profile data may include memory purchase relevant data, such as preferred vendors, acceptable prices or price ranges, loyalty program memberships, credit card information, user home and/or shipping address and the like. These databases are accessed by the application to provide the user with up-to-date, user-specific and best-price options for purchasing memory.

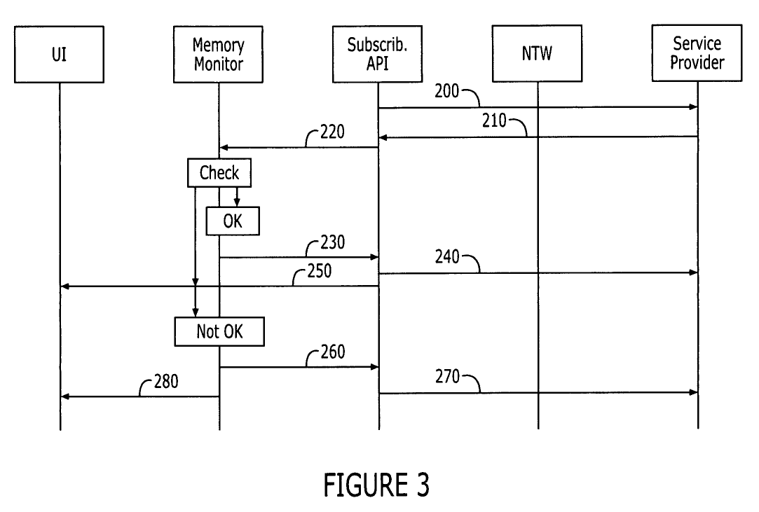

FIG. 3 is a flow diagram depicting a method for monitoring memory and determining memory need, in accordance with an embodiment of the present invention. The memory monitoring that is performed in this illustration is by way of example only. Other memory monitoring methods may also be performed without deviating from the inventive concepts herein disclosed. At step 200, an application that is executed by the mobile terminal sends a “subscribe to service” request through the communication network to a service provider. At step 210, the service provider responds with information related to the service including the memory requirements needed to properly execute the service at the mobile terminal. The application, at step 220, checks with the memory monitor application of the present invention to determine if sufficient memory is available to execute the service on the mobile terminal. If the memory monitor determines that sufficient memory is available, then at step 230, the application is informed, at step 240, the service provider is notified and the subscription is confirmed and, at step 250, the terminal user is informed that service is now available for use. If the memory monitor determines that insufficient memory is available to execute the service, then at step 260, the application is informed, at step 270, the service provider is notified that insufficient memory exists, and at step 280, the terminal user is informed, typically by a visual notice on the display, that insufficient memory exists to properly subscribe to the service.

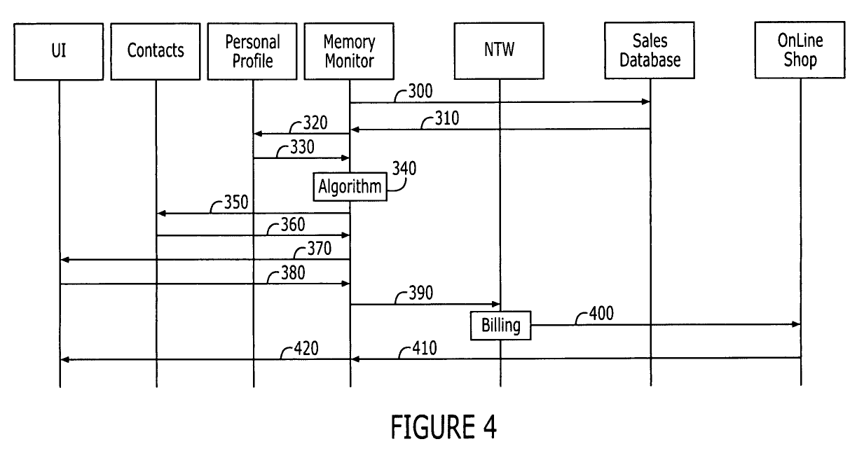

FIG. 4 is a flow diagram depicting a method for generating memory purchase options for a mobile terminal that has insufficient replaceable memory, in accordance with an embodiment of the present invention. The memory purchase option and order placement that is performed in this illustration is by way of example only. Other memory purchase options and order placements may also be performed without deviating from the inventive concepts herein disclosed. In the FIG. 4 flow the memory monitor and purchase option agent application has determined that insufficient memory exists. For example, the terminal has attempted to initiate a subscription to a new service (such as illustrated in FIG. 2) and determined that insufficient memory exists or the terminal has otherwise acquired a large volume of files, such as image files and the memory is either near capacity or at capacity. At step 300, the memory monitor and purchase option agent will communicate, via the communication network, with a remote vendor database. The vendor database will include information about memory vendors, both retail locations and online locations, as well as, memory type, memory brand, prices for memory offered and the like. Additionally, the vendor database will include information related to consummating the purchase, such as online order forms and the like.

The vendor information returned by the database, at step 310, can be localized for the mobile terminal. Localization of vendor data is typically accomplished by using the cellular subscription information, such as the area code of a cellular telephone number, to identify and provide memory vendors options that are local to the area of the cellular subscription. In addition, the application may rely on information from an internal location tracking device, such as a GPS device or the like, to inform the vendor database as to the current location of the mobile terminal. In this fashion, the vendor database is able to return memory purchase options that are specific to the current location of the device. For example, the nearest proximate retail location for purchasing additional memory will be presented to the terminal user as a purchase option. As previously noted the vendor database in alternate embodiment of the invention may be stored at the mobile terminal or at any remote network device.

In addition to accessing the vendor database, the memory purchase option agent application will typically, at step 320, communicate with a personal or user profile database. The user profile database will generally include information that may be relevant to the purchase of memory. For example, the user profile may include preferred vendors, preferred memory prices or preferred price ranges, information regarding customer loyalty membership, credit card information, home and/or shipping address of the user and the like. Additionally, the user profile may include information regarding the user's preference for automatically purchasing memory. For example, the user may pre-configure the application to automatically purchase memory based upon the current state of memory availability or the current price of memory. At step 330, the user profile database returns to the application the requisite user profile information. In the illustrated embodiment of FIG. 4, the user profile database is stored internally within the mobile terminal; however; as discussed above alternate embodiments of the invention will provide for the user profile database to be stored at a remote network device and access to such database will require appropriate network communication.

The memory purchase option application is then executed, at step 340, to determine the purchase options that will be presented to the mobile terminal user. In the illustrated embodiment, the application has generated a purchase option that includes a recommendation to purchase memory from a specific online memory vendor. The application, at step 350 may access the contacts database or other database containing user information, such as the user profile database or the like. The contacts database is accessed to retrieve information that will be used to automatically fill-out the online order form, typically information such as purchaser name, address, telephone number credit card information and the like. At step 360, the contacts database returns the appropriate purchaser information and the memory monitor and purchase option agent application fills-in the online order form that was previously retrieved from the vendor database.

At step 370, the user is presented with the memory purchasing options via the mobile terminal user interface, i.e., a display. The purchasing options may be a list of vendors having the best price, a list of the closest on proximity retail vendors, a list of preferred vendors as designated by the user or any other type of list. In the illustrated embodiment the purchase option that is presented to the terminal user includes a first option to purchase from the specific online memory vendor. As such the mobile terminal user is presented with the online order form, which has been automatically filled-in by the application. The user, via interface with a mobile terminal user interface, such as a touch-screen display or a keyboard can either decline the purchase option or accept the purchase option. If the mobile terminal user accepts the purchase option, at step 380, the order acceptance input is sent to the memory purchase option agent application. The application, in turn, at step 390 sends the billing information to a network billing entity, such as the mobile operator billing system using a Short message Service (SMS) based payment method and, at step 400, confirmation of the billing and the order is communicated to the online vendor.

Once the online vendor has received billing confirmation and the order, at step 410, the online vendor will communicate back to the memory purchase agent application confirmation of the order and, optionally, the delivery schedule. At step 420, the application conveys the order confirmation and the delivery schedule to the mobile terminal, via presentation on the associated terminal display. In due course, the online vendor will deliver the memory using a conventional commercial delivery source.

As such the present invention mitigates problems related to mobile terminals depleting available replaceable memory and subsequently purchasing additional memory. The present invention also addresses the need to provide mobile terminal users with accessory purchase options when needs dictate such. In this regard, the present invention provides computer program products, devices and systems that monitor replaceable memory availability on a mobile terminal device or accessory availability for a mobile terminal device and, based on predetermined thresholds, generate purchasing options for the replaceable memory or accessory. The mobile terminal device may include, but is not limited to, devices that include a memory expansion module, such as a mobile telephone, a personal digital assistant (PDA), a digital imaging device or the like. In this regard, the present invention is able to provide a mobile terminal user options to purchase additional replaceable memory or accessories when the memory is close to capacity or when the accessory is either exhausted or has become commercially available. The purchasing options that are presented to the user will typically take into account best prices for the memory, both at retail locations and online locations, as well ass, user specific purchasing criteria, such as acceptable price range, loyalty program membership, preferred vendors and location of the user and/or the mobile terminal. In addition, the purchasing options that are provided to the user may be such that they are preconfigured by the user to automatically purchase additional memory or an accessory if a certain threshold of memory or accessory capacity is exceeded. As such, the present invention limits the likelihood of the mobile terminal reaching full memory or accessory capacity without the user having purchased additional memory or accessories. In terms of accessories, the invention insures that accessory suppliers have the ability to provide accessory information to users when new accessories are introduced into the market place or when the user has shown a need to acquire such accessories.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A computer program product for providing purchasing options to a mobile terminal user, the computer program product comprising a computer readable storage medium having computer-readable program instructions embodied in the medium, the computer-readable program instructions comprising:
first instructions for monitoring availability of replaceable memory associated with the mobile terminal; and
second instructions for generating one or more memory purchase options, if the first instructions determine that the availability of memory is such that additional memory is recommendable.

2. The computer program product of claim 1, wherein the first instructions for monitoring availability of replaceable memory associated with the mobile terminal further includes instructions for determining if available replaceable memory is no more than a predetermined minimum threshold.

3. The computer program product of claim 2, wherein the second instructions for generating one or more memory purchase options, if the first instructions determine that the availability of replaceable memory is such that additional memory is recommendable further includes instructions for generating one or more memory purchase options, if available replaceable memory is determined to no more than the predetermined minimum threshold.

4. The computer program product of claim 1, wherein the first instructions for monitoring availability of replaceable memory associated with the mobile terminal further includes instructions for predicting a time at which the memory will be exhausted based on a current memory consumption rate.

5. The computer program product of claim 4, wherein the second instructions for generating one or more memory purchase options, if the first instructions determine that the availability of memory is such that additional memory is recommendable further comprises generating one or more memory purchase options, if the predicted time is determined to be less than or equal to a predetermined threshold.

6. The computer program product of claim 1, wherein the second instructions for generating one or more memory purchase options further include instructions for displaying the one or more memory purchase options on a display associated with the mobile terminal.

7. The computer program product of claim 1, wherein the second instructions for generating one or more memory purchase options, if the first instructions determine that the availability of memory is such that additional memory is recommendable further includes instructions for generating one or more memory purchase options based on a database of available memory vendors.

8. The computer program product of claim 1, wherein the second instructions for generating one or more memory purchase options, if the first instructions determine that the availability of memory is such that additional memory is recommendable further includes instructions for generating one or more memory purchase options based on a personal profile of the mobile terminal user.

9. The computer program product of claim 1, wherein the second instructions for generating one or more memory purchase options, if the first instructions determine that the availability of memory is such that additional memory is recommendable further includes instructions for generating one or more memory purchase options based on a physical location of the mobile terminal.

10. The computer program product of claim 1, wherein the second instructions for generating one or more memory purchase options, if the first instructions determine that the availability of memory is such that additional memory is recommendable further includes instructions for automatically purchasing additional memory based on preconfigured purchase criteria.

11. The computer program product of claim 10, wherein the second instructions for automatically purchasing additional memory based on preconfigured purchase criteria define the preconfigured purchase criteria as chosen from the group consisting of memory type, memory size, memory brand, price, location of retail source, purchase incentive programs, acceptable forms of payment, and delivery time.

12. The computer program product of claim 1, further comprising third instructions for cleansing the data stored in the memory.

13. The computer program product of claim 12, wherein the third instructions for cleansing the data stored in the memory further include instructions for deleting data stored in the memory that is determined to be unused for a predetermined period of time.

14. The computer program product of claim 12, wherein the third instructions for cleansing the data stored in the memory further includes instructions for cleansing the data stored in the memory on a periodic schedule.

15. The computer program product of claim 1, further comprising third instructions for compressing the data stored in the memory.

16. The computer program product of claim 15, wherein the third instructions for compressing the data stored in the memory further comprises instructions for compressing the data stored in the memory that is determined to be unused for a predetermined period of time.

17. The computer program product of claim 15, wherein the third instructions for compressing the data stored in the memory further comprises instructions for compressing the data based on type of data.

18. A computer program product for providing for purchasing options to a mobile terminal user, the computer program product comprising a computer readable storage medium having computer-readable program instructions embodied in the medium, the computer-readable program instructions comprising:
first instructions for monitoring availability of one or more accessories associated with the mobile terminal; and
second instructions for generating one or more accessory purchase options, if the first instructions determine the availability of one or more accessories associated with the mobile terminal.

19. The computer program product of claim 18, wherein the computer readable storage medium is disposed within a mobile terminal.

20. The computer program product of claim 18, wherein the first instructions for monitoring availability of accessories associated with the mobile terminal further includes instructions for determining if the mobile terminal has a need to acquire the one or more accessories.

21. The computer program product of claim 20, wherein the second instructions for generating one or more accessory purchase options, if the first instructions determine the availability of one or more accessories associated with the mobile terminal further comprises generating one or more accessory purchase options, if a determination is made that the mobile terminal has a need to acquire the one or more accessories.

22. The computer program product of claim 18, wherein the second instructions for generating one or more accessory purchase options further includes instructions for displaying the one or more accessory purchase options on a display associated with the mobile terminal.

23. The computer program product of claim 18, wherein the second instructions for generating one or more accessory purchase options, if the first instructions determine the availability of one or more accessories associated with the mobile terminal further includes instructions for generating one or more accessory purchase options based on a database of available accessory vendors.

24. The computer program product of claim 18, wherein the second instructions for generating one or more accessory purchase options, if the first instructions determine the availability of one or more accessories associated with the mobile terminal further includes instructions for generating one or more accessory purchase options based on a personal profile of the mobile terminal user.

25. The computer program product of claim 18, wherein the second instructions for generating one or more accessory purchase options, if the first instructions determine the availability of one or more accessories associated with the mobile terminal further includes instructions for generating one or more accessory purchase options based on a physical location of the mobile terminal.

26. The computer program product of claim 18, wherein the second instructions for generating one or more accessory purchase options, if the first instructions determine the availability of one or more accessories associated with the mobile terminal further includes instructions for automatically purchasing one or more accessories based on preconfigured purchase criteria.

27. The computer program product of claim 26, wherein the second instructions for automatically purchasing one or more accessories based on preconfigured purchase criteria define the preconfigured purchase criteria as chosen from the group consisting of accessory type, accessory brand, price, location of retail source, purchase incentive programs, acceptable forms of payment, and delivery time.

28. A mobile terminal device, the device comprising:
a memory expansion module that receives removable memory devices;
a processing unit in communication with the memory expansion module that executes an application that monitors the availability of memory associated with the removable memory devices and generates one or more memory purchase options if the monitoring determines that the availability of memory is such that additional memory is recommendable; and
a display in communication with the processing unit that provides a user with a visual display of the one or more memory purchase options.

29. The device of claim 28, further comprising an internal memory unit in communication with the processing unit that stores a list of one more memory vendors, wherein the application accesses the internal memory unit to determine one or more memory vendors when generating the one or more memory purchase options.

30. The device of claim 29, wherein the internal memory unit in communication with the processing unit further stores a list of one more memory prices corresponding to the one or more memory vendors.

31. The device of claim 28, further comprising an internal memory unit in communication with the processing unit that stores a user profile, wherein the application accesses the internal memory unit to determine the user profile when generating the one or more memory purchase options.

32. The device of claim 31, wherein the internal memory unit in communication with the processing unit that stores a user profile further defines the user profile as including one or more profile attributes chosen from the group consisting of preferred vendors, preferred purchase price, vendor loyalty programs, credit card information, and user address.

33. The device of claim 28, further comprising a location tracking device in communication with the processing unit, wherein the application accesses the location tracking device to determine the location of the mobile terminal when generating the one or more memory purchase options.

34. A system for providing memory purchase options to a mobile terminal user, the system comprising:
a mobile terminal device that includes a memory expansion module that receives removable memory devices, a processing unit in communication with the memory expansion module and a display in communication with the processing unit; and
a memory purchase agent application that is in communication with the mobile terminal device that monitors the availability of memory associated with the removable memory devices and generates one or more memory purchase options if the monitoring determines that the availability of memory is such that additional memory is recommendable,
wherein the display of the mobile terminal device provides for a visual display of the one or more memory purchase options generated by the memory purchase agent application.

35. The system of claim 34, wherein the memory purchase agent application is executed at a remote network device that is in network communication with the mobile terminal device.

36. The system of claim 34, further comprising a vendor database in communication with the memory purchase agent application that provides for a list of one more memory vendors, wherein the application accesses the vendor database to determine one or more memory vendors when generating the one or more memory purchase options.

37. The system of claim 36, wherein the vendor database in communication with the memory purchase agent application further provides for a list of one more memory prices corresponding to the one or more memory vendors.

38. The system of claim 36, wherein the vendor database is stored in a network device remote from the mobile terminal device.

39. The system of claim 36, wherein the vendor database is stored in a memory unit that is internal to the mobile terminal device.

40. The system of claim 34, further comprising a user profile database in communication the memory purchase agent application that provides for one or more user profiles, wherein the application accesses the user profile database to determine the user profile when generating the one or more memory purchase options.

41. The system of claim 40, wherein the user profile database in communication the memory purchase agent application that provides for one or more user profiles further defines the user profile as including one or more profile attributes chosen from the group consisting of preferred vendors, preferred purchase price, vendor loyalty programs, credit card information, and user address.

42. The system of claim 40, wherein the user profile database is stored in a network device remote from the mobile terminal device.

43. The system of claim 40, wherein the user profile database is stored in a memory unit that is internal to the mobile terminal device.

44. The system of claim 34, wherein the mobile terminal device further comprises a location tracking device in communication with the processing unit, wherein the application accesses the location tracking device to determine the location of the mobile terminal when generating the one or more memory purchase options.

45. A mobile terminal device, the device comprising:
a processing unit that executes an application that monitors the availability of one or more accessories associated with the mobile terminal device and generates one or more accessory purchasing options if the monitoring determines the availability of one or more accessories associated with the mobile terminal device; and
a display in communication with the processing unit that provides a user with a visual display of the one or more accessory purchase options.

46. The device of claim 45, wherein the application further provides for determining if the mobile terminal has a need to acquire the one or more accessories and generates one or more accessory purchase options, if a determination is made that the mobile terminal has a need to acquire the one or more accessories.

47. The device of claim 45, further comprising an internal memory unit in communication with the processing unit that stores a list of one more accessory vendors, wherein the application accesses the internal memory unit to determine one or more accessory vendors when generating the one or more accessory purchasing options.

48. The device of claim 47, wherein the internal memory unit in communication with the processing unit further stores a list of one more accessory prices corresponding to the one or more accessory vendors.

49. The device of claim 45, further comprising an internal memory unit in communication with the processing unit that stores a user profile, wherein the application accesses the internal memory unit to determine the user profile when generating the one or more accessory purchase options.

50. The device of claim 49, wherein the internal memory unit in communication with the processing unit that stores a user profile further defines the user profile as including one or more profile attributes chosen from the group consisting of preferred vendors, preferred purchase price, vendor loyalty programs, credit card information, and user address.

51. The device of claim 45, further comprising a location tracking device in communication with the processing unit, wherein the application accesses the location tracking device to determine the location of the mobile terminal when generating the one or more accessory purchase options.

52. A system for providing accessory purchase options to a mobile terminal user, the system comprising:
a mobile terminal device that includes a processing unit and a display in communication with the processing unit; and
an accessory purchase agent application that is in communication with the mobile terminal device that monitors the availability of one or more accessories associated with the mobile terminal device and generates one or more accessory purchase options if the monitoring determines the availability of one or more of the accessories,
wherein the display of the mobile terminal device provides for a visual display of the one or more accessory purchase options generated by the accessory purchase agent application.

53. The system of claim 52, wherein the accessory purchase agent application is executed at a remote network device that is in network communication with the mobile terminal device.

54. The system of claim 52, further comprising a vendor database in communication with the accessory purchase agent application that provides for a list of one more accessory vendors, wherein the application accesses the vendor database to determine one or more accessory vendors when generating the one or more accessory purchase options.

55. The system of claim 54, wherein the vendor database in communication with the accessory purchase agent application further provides for a list of one more accessory prices corresponding to the one or more accessory vendors.

56. The system of claim 54, wherein the vendor database is stored in a network device remote from the mobile terminal device.

57. The system of claim 54, wherein the vendor database is stored in a memory unit that is internal to the mobile terminal device.

58. The system of claim 52, further comprising a user profile database in communication the accessory purchase agent application that provides for one or more user profiles, wherein the application accesses the user profile database to determine the user profile when generating the one or more accessory purchase options.

59. The system of claim 58, wherein the user profile database in communication the accessory purchase agent application that provides for one or more user profiles further defines the user profile as including one or more profile attributes chosen from the group consisting of preferred vendors, preferred purchase price, vendor loyalty programs, credit card information, and user address.

60. The system of claim 58, wherein the user profile database is stored in a network device remote from the mobile terminal device.

61. The system of claim 52, wherein the user profile database is stored in a memory unit that is internal to the mobile terminal device.

62. The system of claim 52, wherein the mobile terminal device further comprises a location tracking device in communication with the processing unit, wherein the application accesses the location tracking device to determine the location of the mobile terminal when generating the one or more accessory purchase options.

63. A computer program for providing purchasing options to a mobile terminal user, the computer program having computer-readable program instructions, the computer-readable program instructions comprising:
first instructions for monitoring availability of replaceable memory associated with the mobile terminal; and
second instructions for generating one or more memory purchase options, if the first instructions determine that the availability of memory is such that additional memory is recommendable.

64. The computer program of claim 63, wherein the first instructions for monitoring availability of replaceable memory associated with the mobile terminal further includes instructions for determining if available replaceable memory is no more than a predetermined minimum threshold.

65. The computer program of claim 64, wherein the second instructions for generating one or more memory purchase options, if the first instructions determine that the availability of replaceable memory is such that additional memory is recommendable further includes instructions for generating one or more memory purchase options, if available replaceable memory is determined to no more than the predetermined minimum threshold.

66. The computer program of claim 63, wherein the first instructions for monitoring availability of replaceable memory associated with the mobile terminal further includes instructions for predicting a time at which the memory will be exhausted based on a current memory consumption rate.

67. The computer program of claim 66, wherein the second instructions for generating one or more memory purchase options, if the first instructions determine that the availability of memory is such that additional memory is recommendable further comprises generating one or more memory purchase options, if the predicted time is determined to be less than or equal to a predetermined threshold.

68. The computer program of claim 63, wherein the second instructions for generating one or more memory purchase options, if the first instructions determine that the availability of memory is such that additional memory is recommendable further includes instructions for automatically purchasing additional memory based on preconfigured purchase criteria.

69. The computer program of claim 68, wherein the second instructions for automatically purchasing additional memory based on preconfigured purchase criteria define the preconfigured purchase criteria as chosen from the group consisting of memory type, memory size, memory brand, price, location of retail source, purchase incentive programs, acceptable forms of payment, and delivery time.

70. A computer program for providing for purchasing options to a mobile terminal user, the computer program having computer-readable program instructions, the computer-readable program instructions comprising:
first instructions for monitoring availability of one or more accessories associated with the mobile terminal; and
second instructions for generating one or more accessory purchase options, if the first instructions determine the availability of one or more accessories associated with the mobile terminal.

71. The computer program of claim 70, wherein the first instructions for monitoring availability of accessories associated with the mobile terminal further includes instructions for determining if the mobile terminal has a need to acquire the one or more accessories.

72. The computer program of claim 71, wherein the second instructions for generating one or more accessory purchase options, if the first instructions determine the availability of one or more accessories associated with the mobile terminal further comprises generating one or more accessory purchase options, if a determination is made that the mobile terminal has a need to acquire the one or more accessories.

73. The computer program of claim 70, wherein the second instructions for generating one or more accessory purchase options, if the first instructions determine the availability of one or more accessories associated with the mobile terminal further includes instructions for automatically purchasing one or more accessories based on preconfigured purchase criteria.

74. The computer program of claim 73, wherein the second instructions for automatically purchasing one or more accessories based on preconfigured purchase criteria define the preconfigured purchase criteria as chosen from the group consisting of accessory type, accessory brand, price, location of retail source, purchase incentive programs, acceptable forms of payment, and delivery time.

75. A user interface application for a mobile terminal, the user interface application comprising:
first instructions for displaying to a mobile terminal user one or more memory purchase options; and
second instructions for effecting the purchase of memory based on user inputs to the displayed memory purchase options.

76. The user interface application of claim 75, wherein the first instructions for displaying to a mobile terminal user one or more memory purchase options is triggered by monitoring available memory in the mobile terminal.

77. The user interface application of claim 75, wherein the first instructions for displaying to a mobile terminal user one or more memory purchase options further comprises displaying to a mobile terminal user one or more network merchant memory purchase options.

78. The user-interface application of claim 75, wherein the second instructions for effecting the purchase of memory based on user inputs to the displayed memory purchase options further comprises communicating a memory purchase order to a networked merchant

79. A user interface application for a mobile terminal, the user interface application comprising:
first instructions for displaying to a mobile terminal user one or more mobile terminal accessory purchase options; and
second instructions for effecting the purchase of a mobile terminal accessory based on user inputs to the displayed mobile terminal accessory purchase options.

80. The user interface application of claim 79, wherein the first instructions for displaying to a mobile terminal user one or more mobile terminal accessory purchase options is triggered by monitoring the mobile terminal's need for a mobile terminal accessory.

81. The user interface application of claim 79, wherein the first instructions for displaying to a mobile terminal user one or more mobile terminal accessory purchase options is triggered by monitoring availability of newly available mobile terminal accessories.

82. The user interface application of claim 79, wherein the first instructions for displaying to a mobile terminal user one or more mobile terminal accessory purchase options further comprises displaying to a mobile terminal user one or more network merchant mobile terminal accessory purchase options.

83. The user-interface application of claim 79, wherein the second instructions for effecting the purchase of mobile terminal accessory based on user inputs to the displayed mobile terminal accessory purchase options further comprises communicating a mobile terminal accessory purchase order to a networked merchant.
